(19) United States
(12) Patent Application Publication
(10) Pub. No.: US 2007/0124169 A1
(43) Pub. Date: May 31, 2007

(54) NETWORKED SYSTEM OF THIN CLIENT DIAGNOSTIC IMAGING SCANNERS

(76) Inventors: Russell Robert Irving, Ballston Lake, NY (US); Stephen R. Crowley, Brookfield, WI (US); David Matthew Deaven, Delafield, WI (US); Richard Lee Frowein, Waukesha, WI (US); Robert Franklin Senzig, Germantown, WI (US); Rasiklal Punjalal Shah, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/164,616

(22) Filed: Nov. 30, 2005

(51) Int. Cl. G06Q 10/00; G06K 9/00; G06F 15/173

(52) U.S. Cl. 705/2; 382/128; 709/238

(57) ABSTRACT

A medical imaging scanner is constructed such that its data acquisition subsystem is located at the site of a medical imaging scan. Through either a wired or wireless link, the raw data collected during the scan is transmitted to a remotely located image processing and reconstruction subsystem that processes the raw data to reconstruct an image. Preferably, the remotely located image processing and reconstruction subsystem is located at a centralized facility and is connected to receive and process data from various scanners. The remotely located image processing and reconstruction subsystem is preferably equipped to process and reconstruct an image from data acquired with multiple types of medical imaging scanners. In this regard, reconstruction of a CT, PET, MR, x-ray, or the like image can be carried out remotely from the scanner used to acquire the corresponding raw data.

### BACKGROUND OF THE INVENTION

The present invention relates generally to diagnostic imaging systems and, more particularly, to a networked environment of medical imaging scanners that support the collection of medical imaging data remote from a shared image processing and reconstruction center. In this regard, the present invention is particularly applicable with a networked environment having a thin client scanner that is connected to a remote image processing center. As such, data acquired with the thin client scanner, which is not capable of image reconstruction, can be communicated to a remote processing center for image reconstruction.

Medical imaging is increasingly being used for non-invasively detecting and diagnosing a host of medical conditions. Through various modalities, such as computed tomography (CT), positron emission tomography (PET), magnetic resonance imaging (MRI), and x-ray imaging, physicians and other health care providers are able to diagnosis and measure the severity of various medical conditions, including, but not limited to cancer, trauma, heart disease, etc. Since each imaging modality provides a unique benefit, medical treatment facilities and imaging centers typically will have multiple scanners representative of the various modalities available for physicians to acquire imaging data of a patient.

Known medical imaging scanners are stand-alone devices wherein the entire imaging system is located at one physical location—the application site. In this regard, the imaging bay, the operator interface, the data acquisition subsystems, and the image processing and reconstruction subsystem are all integrated into a single medical imaging scanner. As a result, known medical imaging scanners are relatively large and therefore occupy large amounts of floor space. Moreover, as each scanner is a fully stand-alone device, that is, has all the hardware and software necessary for data collection and image reconstruction, the scanner can be quite costly to purchase and maintain. Adding to the costs is the redundancy in image processing capabilities.

That is, increasingly, medical treatment facilities, e.g. hospitals, and imaging centers are equipped with multiple scanners of the same type. For example, a medical imaging center that specializes in CT and MRI will have multiple CT scanners as well as multiple MR scanners. Each scanner is a stand-alone device and, as such, is equipped with its own data collection subsystem and its own image processing subsystem. Accordingly, not only must the hardware of each machine be maintained, but the software, which is redundant across the scanners, must be maintained at each scanner. Moreover, as more imaging and reconstruction protocols are being developed, the memory and processing capabilities of each scanner must be periodically updated. All of which leads to increased operating and maintenance costs.

Additionally, since each scanner is a stand-alone machine, each machine is typically not fully utilized. That is, when a scanner is not in use, for scheduled maintenance, repair, or down-time, not only is the data collection subsystem not being used, but neither is the image reconstruction subsystem. The image reconstruction subsystem, which is largely a software driven subsystem, is therefore unnecessarily idle when the data collection subsystem, a largely hardware driven subsystem, is not in use. Therefore, the down-time of the scanner is unnecessarily exaggerated simply because the scanner hardware is not in use.

Therefore, it would be desirable to design an imaging scanner that is reduced in size by remotely locating the data collection subsystem and image processing subsystem of the scanner from one another. It would also be desirable to provide a network of shared-resources medical imaging scanners to reduce the redundancy typically found in multi-scanner facilities.

### BRIEF DESCRIPTION OF THE INVENTION

The present invention is directed to a network of medical imaging systems that overcomes the aforementioned drawbacks.

A medical imaging scanner is constructed such that its data acquisition subsystem is located at the site of a medical imaging scan. Through either a wired or wireless link, the raw data collected during the scan is transmitted to a remotely located image processing and reconstruction subsystem that processes the raw data to provide a diagnostically valuable image. Preferably, the remotely located image processing and reconstruction subsystem is located at a centralized facility and is connected to receive and process data from various scanners. The remotely located image processing and reconstruction subsystem is preferably equipped to process and reconstruct an image from data acquired with multiple types of medical imaging scanners. In this regard, reconstruction of a CT, PET, MR, x-ray, or the like image can be carried out remotely from the scanner used to acquire the corresponding raw data. Moreover, by centralizing data processing and image reconstruction, maintenance relating to the image processing and reconstruction subsystem can be carried out on a single subsystem rather than multiple scanners.

Therefore, in accordance with one aspect of the present invention, an imaging system includes an imaging bay located at an application site and a data acquisition subsystem proximate the imaging bay at the application site. The imaging system further has an image processing and reconstruction subsystem operably connected to receive data from the data acquisition subsystem and located remotely from the application site.

In accordance with another aspect of the present invention, a network of medical imaging scanners is presented and includes a plurality of imaging scanners. At least one of the imaging scanners is a thin client scanner and is therefore incapable of processing acquired imaging data to reconstruct an image therefrom. The network also includes an image processing and reconstruction center that is remotely located from the thin client scanner. The network further includes a communications link at least linking the thin client scanner to the image processing and reconstruction center such that imaging data acquired with the thin client scanner can be reconstructed into an image.

According to another aspect, the present invention is embodied in a method of acquiring medical imaging data that includes prescribing a medical imaging scan and acquiring data medical imaging data with a given scanner. The method further includes the step of routing the medical imaging data to a remotely located image processing center. An image is then reconstructed from the medical imaging data at the image processing center.

Various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a schematic representation of a medical imaging scanner according to the present invention.

FIG. 2 is a schematic representation of a networked scanner environment according to one aspect of the present invention.

FIG. 3 is a schematic representation of a networked scanner environment according to another aspect of the present invention.

FIG. 4 is a schematic representation of a networked scanner environment according to yet a further aspect of the present invention.

FIG. 5 is a schematic representation of a networked scanner environment according to yet another aspect of the present invention.

FIG. 6 is a pictorial view of an exemplary thin client CT imaging system.

FIG. 7 is a block schematic diagram of the system illustrated in FIG. 6.

### DETAILED DESCRIPTION OF THE PREFERRED EMBODIMENT

The present invention is directed to a networked environment of medical imaging scanners. As will be described, this networked environment provides processor load balancing and hardware redundancy. Additionally, the networked environment facilitates image processing and reconstruction remotely from the scan site thereby facilitating a reduction in the size, hardware, and software needs of the scanners of the network. In one preferred embodiment, a central image processing and reconstruction center receives and processes data for image reconstruction for a number of remotely located scanners. The central image processing and reconstruction center is preferably constructed to process data from a heterogeneous network of scanners.

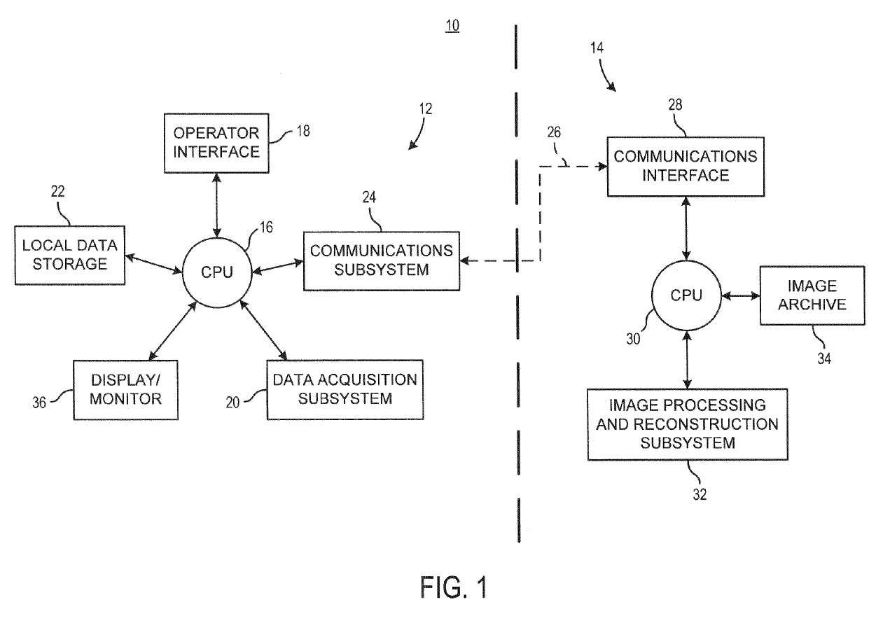

Referring now to FIG. 1, a thin client medical imaging scanner according to the present invention is shown. The scanner 10 is constructed such that scan prescription and data collection is carried out at the scan site 12, but image processing and reconstruction is carried out at a remote site 14. In this regard, scanner 10 includes a system controller 16 that coordinates prescription of the scan based on inputs entered by the operator via operator interface 18. The system controller, based on the operator inputs defining the particulars of the scan, controls a data acquisition subsystem 20 to acquire imaging data from a subject positioned in an imaging bay (not shown). Data acquired during the course of the scan is preferably stored in locally volatile memory 22. After data collection, the locally stored data is then fed to a communications subsystem 24 that transmits the imaging data to the remote site 14 via communications link 26. The communications link may either be a wired or wireless link. As will be described, the communications link preferably supports two-way communication.

At the remote site 14, communications interface 28 receives the imaging data from the remotely located communications subsystem 24. A CPU 30 at the remote site 14 routes the received data to an image processing and reconstruction subsystem 32 that reconstructs an image of the received data in accordance with known image reconstruction techniques. After the received data has been processed into an image, that image is preferably stored on an image archive 34 and transmitted to the remote subsystem across the communications link 26 so that the image can be displayed locally at the scan site 12 on computer monitor 36.

While a number of communication techniques are contemplated, communication between the communications subsystem 24 at the scan site 12 and the communications interface at the remote site 14 is preferably via a large bandwidth, high speed connection that supports at least a 20 megabyte per second transfer rate. In this regard, not only does the communications link carry the imaging data and resulting image thereacross, but also allows transmission of operator's instructions with respect to the type of image reconstruction to be employed at the remote site. As such, an operator at the scan site maintains control of the image reconstruction process despite that reconstruction being carried out remotely or off-site.

The communications link between the at-site communications subsystem 24 and the off-site communications interface 28 may be of any acceptable type, including conventional telephone lines, fiber optics, cable modem links, digital subscriber lines, wireless data transfer systems, or the like. The communications subsystem and the communications interface each have hardware and software of generally known design thereby permitting each to establish network connection and exchange data therebetween. In some cases, during periods when no data is exchanged between the scan site and the remote site, the communications link can be terminated. In other cases, the communications link is maintained continuously.

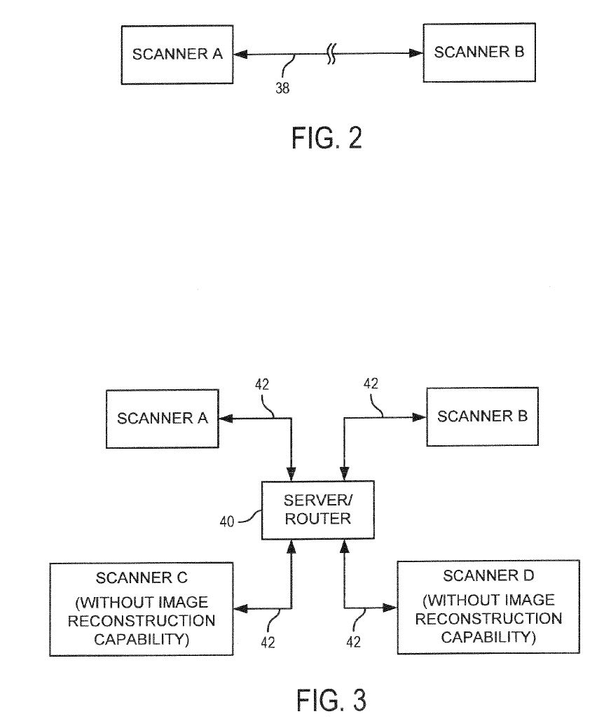

In accordance with further embodiments of the present invention, this high-speed, high bandwidth communication is exploited in a shared-resources network. One embodiment is illustrated in FIG. 2. In the embodiment of FIG. 2, two conventional scanners Scanner A and Scanner B are remotely located from one another but networked to one another by communications link 38. This communications link provides bi-directional communication between Scanner A and Scanner B. As both scanners are of conventional construction, each scanner is capable of scan-site image reconstruction as is customary for stand-alone scanners; however, because of communications link 38, the image processing and reconstruction subsystem of one scanner can be accessed and utilized by the other scanner. In this regard, should one scanner have a hardware/software issue that affects image reconstruction, data collection can still be carried out with the image reconstruction being carried out on the networked scanner. Moreover, if the processing requirements of a given scan are better suited for image reconstruction with the image processing and reconstruction subsystem of one scanner, the acquired raw data can be routed to that scanner. Thus, the heretofore redundancy in software is mitigated.

Still referring to FIG. 2, it is contemplated that either Scanner A or Scanner B may be constructed without an image processing and reconstruction subsystem in accordance with the scanner described with respect to FIG. 1. In this regard, the image processing and reconstruction subsystem operates as a central processing center that is capable of image reconstruction for more than one scanner. As such, one scanner is of conventional design and the other scanner is a thin client scanner in accordance with the present invention.

One skilled in the art will appreciate that while only two scanners are shown networked in FIG. 2, it is contemplated that more than two scanners can be networked to provide further redundancy and resource sharing. In this regard, it is contemplated that one or more of the scanners can be designated for data collection and image reconstruction and storage, and other scanners of the network utilized only for data collection. One skilled in the art will appreciate that a server/router (not shown) may be used to control routing of data between the networked scanners. In this regard, it is contemplated that a stand-alone server/router may be used or one of the scanners may include hardware/software to provide server/router functions.

Referring now to FIG. 3, a networked environment according to another embodiment of the present invention is shown. In this embodiment, the network is comprised of conventional scanners (Scanners A and B) as well as thin client scanners (Scanners C and D). Operation in this network is similar to that of the network illustrated in FIG. 2 with the scanners being connected to provide hardware redundancy and processor load balancing. In this embodiment, however, Scanner A and Scanner B may be used for data collection and image reconstruction whereas Scanner C and Scanner D may only be used for data collection. Thus, data collected with Scanner C or Scanner D is routed, under the direction of server/router 40, to either Scanner A or Scanner B via communications network 42 for image reconstruction. As such, the image processing and reconstructions subsystems of Scanners A or B are used to reconstruct an image of the data collected with Scanners C or D. It is noted that since Scanner C and Scanner D are equipped with a computer monitor, the images reconstructed by Scanners A or B may be routed for display to Scanners C or D.

In the embodiment of FIG. 3, a stand-alone server/router 40 is shown; however, one skilled in the art will appreciate that one of the scanners may operate as a server and include a router for routing communications between the networked scanners.

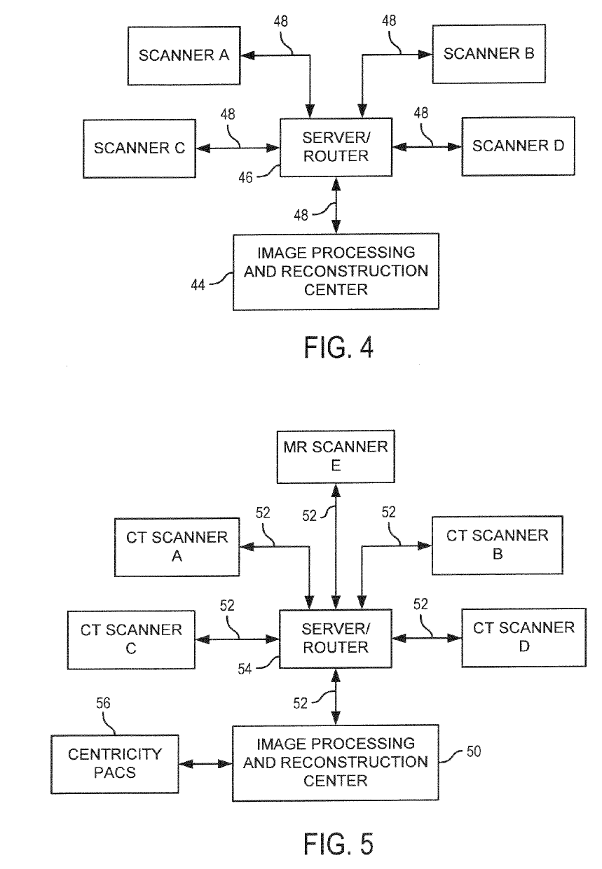

In the embodiment illustrated in FIG. 4, none of the scanners includes an image processing and reconstruction subsystem. In this regards, Scanners A, B, C, and D are all thin client machines, such as that described with respect to FIG. 1. The scanners are constructed only for data collection and image display, but are incapable of image reconstruction. For image reconstruction, a remote and centralized image processing and reconstruction subsystem 44 is linked to the scanners via server/router 46 and communications network 48. Although a single central image processing center is shown, it is understood that the present invention contemplates the use of multiple remote image processing centers, each capable of communicating with remote scanners. Like the embodiments illustrated above, the networked scanners advantageously provide processor load balancing and hardware redundancy. Moreover, as each scanner is a thin client machine, each scanner occupies less floor space, requires less maintenance, and is less costly than conventional medical imaging scanners. The remote and centralized image processing and reconstruction subsystem 44 includes multiple receive channels to support simultaneous reception of data from multiple scanners and the simultaneous transmission of images to multiple scanners.

In one implementation of the embodiment illustrated in FIG. 4, Scanners A, B, C, and D are located within a common medical treatment facility but the centralized image processing and reconstruction subsystem 44 is located off-site in a centralized processing system that preferably has multiple image processing subsystems for carrying out image reconstruction for scanners at several treatment and/or imaging sites. However, it is contemplated that each scanner may be located in an imaging suite of a medical treatment facility, e.g., hospital, and the central image processing subsystem 44 may be located remotely from the imaging suite but within the medical treatment facility. For example, the image processing subsystem 44 may be located in a server/IT room of the medical treatment facility especially designed for housing servers, routers, and the like.

In the embodiment illustrated in FIG. 4, the network is a homogeneous network. That is, each of the scanners is of a common modality. In the embodiment illustrated in FIG. 5, a heterogeneous network of scanners comprising multiple modalities is shown. The network is shown to have five scanners. Four of the scanners are CT scanners (Scanners A, B, C, and D) and one scanner is an MR scanner (Scanner E). The scanners (A, B, C, D, and E) are connected to a common centralized image processing and reconstruction subsystem 50. Subsystem 50 includes processors and software to reconstruct images from the various scanners despite the network being heterogeneous. Communication with processing subsystem 50 is through a communications network 52 and router/server 54. It is understood that the router/server may be integrated with one of the scanners or may be a stand-alone device.

As further shown, the centralized processing and reconstruction subsystem 50 may also be connected to a picture archiving and communication system (PACS) 56. The PACS connection to the image processing subsystem 50 provides a centralized, single-point connection image archival network. As such, images from all the scanners can be stored and archived via a single connection with the image processing subsystem 50.

As described above, the present invention includes a communications link that connects a remote scanner to a remote image processing and reconstruction center. It is understood that communication between the scanner and remote reconstruction center may be over the Internet, or alternatively, be via direct dial-up links through dedicated lines, an intranet, or public communication systems. In this regard, it is understood that the communication link may be of any acceptable type, including conventional telephone lines, fiber optics, cable modem links, digital subscriber lines, wireless data transfer systems, or the like. It is preferred that the communication link be of sufficient bandwidth to support 20 MB/sec. communication. However, it is contemplated that other communication speeds may be used to transfer data while maintaining overall system performance at an acceptable level. Moreover, the scanners as well as the remote image processing and reconstruction center include hardware, firmware, and/or software to facilitate the transmission and reception of data across the communications link.

As described above, the present invention is particularly applicable to medical treatment/imaging facilities having medical scanners on-site. The types of medical scanners contemplated include, but are not limited to CT scanners, MR imaging machines, PET scanners, and x-ray imaging machines. It is also understood that the present invention is applicable with stationary or fixed scanners as well as mobile scanners. In this regard, each scanner may be recognized by a fixed network address or, in the context of mobile scanners, have various network addresses. Further, the present invention may be used with mobile scanners, such as those found in ambulatory vehicles, that are mobilized in order to service patients at various medical facilities or in route to a medical treatment facility.

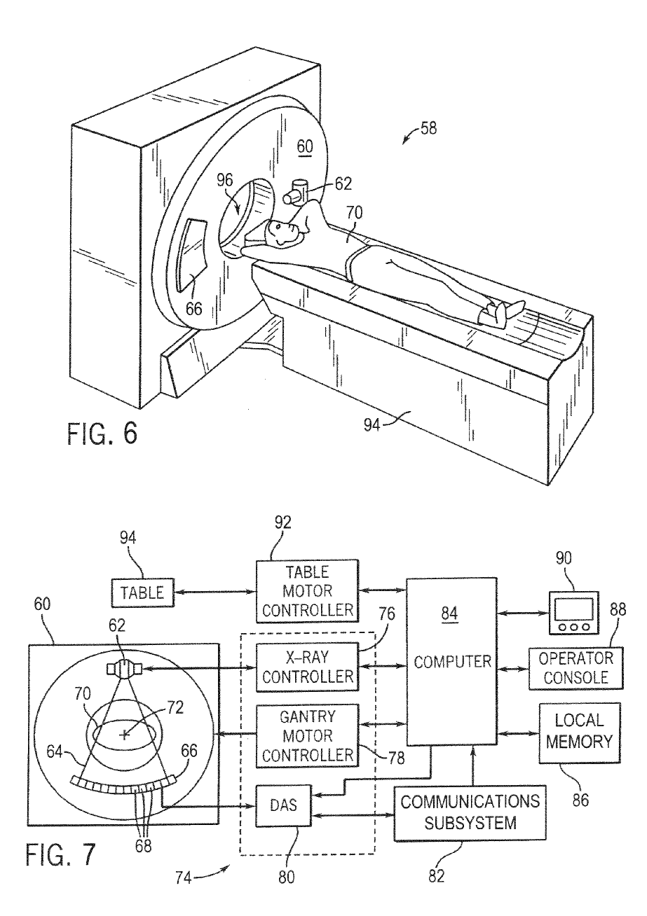

As set forth herein, the present invention is applicable with medical image scanners of various modalities. For purposes of illustration, an exemplary thin client CT scanner is illustrated in FIGS. 6-7; however, it is understood that the present invention is applicable with MR scanners, PET scanners, x-ray machines, and the like. Referring to FIGS. 6 and 7, the exemplary thin client CT imaging system 58 includes a gantry 60 housing an x-ray source 62 that projects a beam of x-rays 64 toward a detector array 66 on the opposite side of the gantry 60. Detector array 66 is formed by a plurality of detectors 68 which together sense the projected x-rays that pass through a medical patient 70. Each detector 68 produces an electrical signal that represents the intensity of an impinging x-ray beam and hence the attenuated beam as it passes through the patient 70. During a scan to acquire x-ray projection data, gantry 60 and the components mounted thereon rotate about a center of rotation 72.

Rotation of gantry 60 and the operation of x-ray source 62 are governed by a control mechanism 74. Control mechanism 74 includes an x-ray controller 76 that provides power and timing signals to an x-ray source 62 and a gantry motor controller 78 that controls the rotational speed and position of gantry 60. A data acquisition system (DAS) 80 in control mechanism 74 samples analog data from detectors 68 and converts the data to digital signals for subsequent processing. In contrast to conventional CT scanners, CT system 58 is constructed without an image reconstructor that performs high speed reconstruction. In this regard, the CT system includes a communications subsystem 82 that transfers the digital signals to a remote image processing and reconstruction subsystem (not shown) whereat the digital signals are reconstructed in accordance with known reconstruction algorithms. The reconstructed image is then fed back to the communications subsystem 82 whereupon the image is applied as an input to computer 84 which stores the image in local memory 86 or displays the image on monitor 90. It is understood that the communications subsystem includes transmitters, receivers, and the like to facilitate the bidirectional communication with the remote image processing and reconstruction center.

Computer 84 also receives commands and scanning parameters from an operator via console 88 that has a keyboard. Monitor 90 allows the operator to observe the reconstructed image and other data from computer 84. The operator supplied commands and parameters are used by computer 84 to provide control signals and information to DAS 80, x-ray controller 76 and gantry motor controller 78. In addition, computer 84 operates a table motor controller 92 which controls a motorized table 94 to position patient 70 and gantry 60. Particularly, table 94 moves portions of patient 70 through a gantry opening 96.

Therefore, an imaging system is disclosed and includes an imaging bay located at an application site and a data acquisition subsystem proximate the imaging bay at the application site. The imaging system further has an image processing and reconstruction subsystem operably connected to receive data from the data acquisition subsystem and located remotely from the application site.

A network of medical imaging scanners is also presented and includes a plurality of imaging scanners. At least one of the imaging scanners is a thin client scanner and is therefore incapable of processing acquired imaging data to reconstruct an image therefrom. The network also includes an image processing and reconstruction center that is remotely located from the thin client scanner. The network further includes a communications link at least linking the thin client scanner to the image processing and reconstruction center such that imaging data acquired with the thin client scanner can be reconstructed into an image.

The present invention is also embodied in a method of acquiring medical imaging data that includes prescribing a medical imaging scan and acquiring data medical imaging data with a given scanner. The method further includes the step of routing the medical imaging data to a remotely located image processing center. An image is the reconstructed from the medical imaging data at the image processing center.

The present invention has been described in terms of the preferred embodiment, and it is recognized that equivalents, alternatives, and modifications, aside from those expressly stated, are possible and within the scope of the appending claims.

What is claimed is:

1. An imaging system comprising:
an imaging bay located at an application site;
a data acquisition subsystem proximate the imaging bay at the application site; and
an image processing and reconstruction subsystem operably connected to receive data from the data acquisition subsystem and located remotely from the application site.

2. The imaging system of claim 1 wherein the image processing and reconstruction subsystem and the data acquisition subsystem are operably connected to one another via a wireless link.

3. The imaging system of claim 1 wherein the image processing and reconstruction subsystem and the data acquisition subsystem are operably connected to one another via a wired link.

4. The imaging system of claim 1 wherein the application site is one imaging suite of a medical treatment facility and the image processing and reconstruction subsystem is located in a central processing center remotely located from the one imaging suite.

5. The imaging system of claim 4 wherein the central processing center is located off-site from the medical treatment facility.

6. The imaging system of claim 1 further comprising a display at the application site that is configured to display an image reconstructed by the image processing and reconstruction subsystem.

7. The imaging system of claim 1 wherein the data acquisition subsystem includes components to acquire CT data of a subject positioned in the imaging bay.

8. The imaging system of claim 1 wherein the data acquisition subsystem includes components to acquire MR data of a subject positioned in the imaging bay.

9. The imaging system of claim 1 wherein the image processing and reconstruction processing subsystem is configured to process and reconstruct an image from data acquired with a data acquisition subsystem of another imaging system at another application site.

10. The imaging system of claim 1 further comprising a prescription control interface proximate the imaging bay at the application site.

11. A network of medical imaging scanners, the network comprising:
a plurality of imaging scanners, each designed to acquire imaging data from a subject, wherein at least one scanner is a thin client scanner that is incapable of processing imaging data to reconstruct an image;
an image processing and reconstruction center remotely situated from the thin client scanner, the image processing and reconstruction center configured to processing imaging data and reconstruct an image therefrom; and
a communications link at least linking the thin client scanner to the image processing and reconstruction center such that imaging data acquired with the thin client scanner can be reconstructed into an image.

12. The network of claim 11 wherein the image processing and reconstruction center is disposed within one of the plurality of imaging scanners.

13. The network of claim 11 wherein each of the plurality of imaging scanners is incapable of processing acquired imaging data into an image and wherein the image processing and reconstruction center is remotely located from each of the plurality of imaging scanners.

14. The network of claim 11 wherein each of the plurality of imaging scanners is located at a respective application site such that the plurality of imaging scanners is located remotely from one another.

15. The network of claim 14 wherein image processing and reconstruction center is remotely located from the application sites.

16. The network of claim 14 wherein the plurality of imaging scanners is located within a common medical treatment facility and wherein the image processing and reconstruction center is located off-site from the common medical treatment facility.

17. The network of claim 11 wherein the plurality of imaging scanners includes scanners of various modalities.

18. The network of claim 17 wherein the various modalities include at least two of MR, CT, X-ray, and PET.

19. The network of claim 11 further comprising an image storage and archival database remotely located from the plurality of imaging scanners.

20. A method of acquiring medical imaging data comprising the steps of:
prescribing a medical imaging scan;
acquiring data medical imaging data with a given scanner;
routing the medical imaging data to a remotely located image processing center; and
reconstructing an image from the medical imaging data at the image processing center.

21. The method of claim 20 further comprising the steps of routing the reconstructed image to the scan site and displaying the reconstructed image with the given scanner.

22. The method of claim 20 wherein the remotely located image processing center is located in a scanner remotely located from the given scanner.

23. The method of claim 20 further comprising the step of archiving the reconstructed image on an archival database remotely located from the given scanner.

24. The method of claim 20 wherein prescribing the medical imaging scan is performed at a scan site where the given scanner is located, the scan site being remotely located from the remotely located image processing center.

25. The method of claim 24 wherein the remotely located image processing center is located at an off-site facility remote from the scan site.

26. The method of claim 20 wherein the given scanner is incapable of image reconstruction.

27. The method of claim 20 wherein the given scanner is one of an MR scanner, a CT scanner, an ultrasound machine, or a PET scanner.
